(19) United States
(12) Patent Application Publication
(10) Pub. No.: US 2016/0247228 A1
(43) Pub. Date: Aug. 25, 2016

(54) SYSTEM FOR OPTIMIZING FUND USAGE IN RETIREMENT PLANNING

(71) Applicant: BANK OF AMERICA CORPORATION, CHARLOTTE, NC (US)

(72) Inventors: Jeanne Ferullo Connolly, Braintree, MA (US); Katherine Dintenfass, Charlotte, NC (US); Matthew Hsieh, Charlotte, NC (US); Carrie Anne Hanson, Charlotte, NC (US); Dariane Katinka Hunt, Concord, MA (US)

(21) Appl. No.: 14/626,792

(22) Filed: Feb. 19, 2015

(51) Int. Cl. G06Q 40/06

(52) U.S. Cl. CPC G06Q 40/06

(57) ABSTRACT

Embodiments of the invention comprise systems, computer program products, and methods for retirement planning. The financial institution accesses the values of assets and liabilities and determines estimated inflows and outflows from past inflows and outflows and any other significant future events over the network from various servers, systems, and devices that store transaction information. The financial institution calculates an available fund amount that a user can spend over a period of time, and an age parameter indicating the age at which the user's inflows and assets will not be able to cover the user's outflows. The financial institution displays the information in an interactive interface and allows for optimization of available fund amount or the age parameter using a location change, peer information, and available financial products. Additionally, the user may set goals, and the financial institution may monitor the user's transactions and provide alerts to the user.

### FIELD

This invention relates generally to a system that aids in retirement planning, and more particularly to a system that provides improved retirement planning content to the user.

### BACKGROUND

Retirement planning is focused on determining an amount of funds that the user needs to save before retiring. It is difficult for users to take control of retirement planning in order to determine, adjust, and optimize the lifestyle the user may be able to have based on different retirement planning scenarios.

### BRIEF SUMMARY

Embodiments of the present invention address the above needs and/or achieve other advantages by providing apparatuses (e.g., a system, computer program product, and/or other device) and methods that improve the retirement planning for users (e.g., customers) and allows the users to factor in different variables (e.g., age, spending amounts over time, events that may affect retirement planning, or the like).

As discussed throughout, the financial institution may take or receive a number of actions, for example accessing information, receiving information, sending information, displaying information, or the like, and it should be understood that financial institution may take these actions through the retirement planning application 17, the retirement planning systems 10, the network 2, and/or other systems as discussed in part in FIG. 8. As such, the financial institution accesses the values of the assets and liabilities of users 9 over the network 2 from various servers, systems, and devices that store asset and liability information of the users 9; determines estimated inflows and outflows from past inflows and outflows and any other significant future events over the network 2 from various servers, systems, and devices that store transaction information (e.g., accounts within the asset and liability applications); calculates an available fund amount that a user 9 can spend over a period of time; calculates the an age parameter indicating the age at which the users inflows and assets will not be able to cover the user's outflows (e.g., when the user's funds are depleted); and displays the information in an interactive interface over the network 2 that allows the user 9 to make adjustments to the available fund amount and/or the age parameter to adjust retirement planning. Moreover, the user 9 may optimize the available funds amount and/or the age parameter by optimizing the values based on a current cost of living in a current location and a new cost of living in a potential new location; based on the decisions of peers with respect to increasing assets, decreasing liabilities, increasing in-flows, decreasing outflows, or the like; or based on financial products offered by the financial institution and for which the user qualifies.

Embodiments of the present invention comprises systems, computer program products, and computer implemented methods for accessing and analyzing assets and liabilities for retirement planning. The invention comprises accessing the assets and the liabilities of a user over a network of servers, wherein the assets include illiquid assets and liquid assets; determining asset values and liability values; determining user information; determining fund in-flows and fund out-flows for the assets and the liabilities over a past time period by analyzing transactions for the assets and the liabilities; calculating estimated future fund in-flows and estimated future fund out-flows over a future time period from at least the fund in-flows and the fund out-flows; determining estimated rates of return for the assets that provide returns; calculating an available fund amount for one or more time periods and an age parameter, wherein the available fund amount indicates estimated funds the user is safe to spend above the estimated out-flows over the time period, wherein the age parameter indicates an estimated age when asset values will be depleted, and wherein the available fund amount for the time period and the age parameter are based at least in part on the asset values, the liability values, the estimated rates of return, the estimated future fund in-flows and the estimated future fund out-flows; and displaying the available fund amount for the time period and the age parameter on a retirement planning interface on a user device.

In further accord with an embodiment, the invention comprises determining an optimization parameter that optimizes the available fund amount or the age parameters; calculating an optimized available fund amount and an optimized age parameter; and displaying the optimization parameter, the optimized available fund amount and the optimized age parameter for the time period on a retirement planning interface on a user device.

In another embodiment of the invention, the optimized parameter comprises an optimized location parameter; and wherein the invention further comprises determining current cost of living expenses of the user's current location; determining new cost of living expenses of the new location, wherein the new cost of living expenses are less than the current cost of living expenses; and wherein the optimized available fund amount and the optimized age parameter are based on the new cost of living expenses.

In still another embodiment of the invention, the optimized parameter comprises a peer optimization; and wherein the invention further comprises determining one or more peers of the user; determining peer decisions, wherein the peer decisions comprise at least an investment decision, inflow decision, or outflow decision of one or more peers; determining when the peer decisions result in increases in the assets, decreases in the liabilities, increases in the fund-inflows, or decreases in the fund-outflows; and wherein the optimized available fund amount and the optimized age parameter are based on the peer decisions.

In yet another embodiment of the invention, the optimized parameter comprises a financial product optimization; and wherein the invention further comprises determining financial products for the user; determining when the financial products result in increases in the assets, decreases in the liabilities, increases in the fund-inflows, or decreases in the fund-outflows; and wherein the optimized available fund amount and the optimized age parameter are based on the peer decisions.

In further accord with an embodiment, the invention further comprises determining from the transactions the fund-outflows verses discretionary purchases; determining when the discretionary purchases exceed the available fund amount for one or more time periods; and alerting the user or an advisor when the discretionary purchases exceed the available fund amount for the one or more time periods.

In another embodiment, the invention further comprises displaying an indication of the fund in-flows used to calculate the available fund amount for the one or more time periods; receiving an indication from the user to add an unidentified fund-inflow to the fund in-flows; and wherein calculating the available fund amount and the age parameter is further based on the unidentified fund in-flow.

In still another embodiment, the invention further comprises display an indication of the fund out-flows used to calculate the available fund amount for the one or more time periods; receiving an indication from the user to add an unidentified fund out-flow to the fund out-flows; and wherein calculating the available fund amount and the age parameter is further based on the unidentified fund out-flow.

In yet another embodiment, the invention further comprises receiving a retirement goal related to a desired available fund amount for a time period or an age parameter; determining one or more user actions that could achieve the desired available fund amount or the desired age parameter; and displaying the one or more user actions on the retirement planning interface on the user device.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings.

FIG. 1 illustrates a high level process flow for retirement planning based on fund distributions, in accordance with one embodiment of the present invention.

FIG. 2 illustrates a flow indicating how the available fund amount and/or an age parameter are influenced, in accordance with one embodiment of the invention.

FIG. 3 illustrates a detailed process flow for retirement planning based on fund distributions, in accordance with one embodiment of the present invention.

FIG. 4 illustrates a user interface for calculating and the displaying the results of the retirement planning, in accordance with one embodiment of the present invention.

FIG. 5 illustrates a user interface for illustrating how the available fund amount is calculated, in accordance with one embodiment of the present invention.

FIG. 6 illustrates an optimization and goal process for optimizing the user's retirement planning, in accordance with one embodiment of the present invention.

FIG. 7 illustrates an optimization interface for optimizing retirement planning for the user, in accordance with one embodiment of the present invention.

FIG. 8 illustrates a block system diagram for a retirement planning system environment, in accordance with one embodiment of the present invention.

### DETAILED DESCRIPTION OF EMBODIMENTS OF THE INVENTION

### Glossary of Terms

The following glossary of terms is intended to define the terms solely as they relate to this patent document, and should not be interpreted as definitions of the terms in any other context.

### Account

An “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity.

### Age Parameter

The “age parameter” refers to an estimated age at which the user will not be able to cover the user's outflows (estimated amount of time associated with the amount of available funds based on the user assets, including the user financial accounts). The age parameter is based on the user's assets, liabilities, estimated inflows, estimated outflows, rates of return and interest on assets and liabilities. Stated another way, the age at which the user's outflows are greater than the user's inflows and the user has no additional assets to cover the difference.

### Assets

“Assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like.

### Authentication Information

“Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system.

### Available Balance or Funds

“Funds” or “Available Balance” are a balance in an account that can be invested or withdrawn. For example, the funds may refer to a bank ledger balance minus the amount of any monetary checks in the process of collection. Funds may also be referred to as an available balance, a collected balance, good funds, and usable funds.

### Available Fund Amount or Amount of Spendable Funds

The “available fund amount” or “amount of spendable funds” is the amount of money a user can spend above the user's cost of living expenses (e.g., essential or semi-essential expenses) for entertainment, vacations, gifts, or other like non-essential expenses (e.g., fun money, safe to spend amount, or the like) while maintaining enough funds to reach a certain age (e.g., age parameter at which the user's funds will be depleted and will no longer be able to cover the outflows). For example, the amount of funds left over after the difference between the in-flows and out-flows are determined.

### Bank Account or Financial Account

A “bank account” is a financial account between a bank customer and a financial institution. Examples of bank accounts include a deposit account, such as a transactional account (e.g., a banking account), a savings account, an investment account, a money market account, a time deposit, a demand deposit, a pre-paid account, a credit account, or the like.

### Checking Account

A “checking account” is a deposit account held at a bank or other financial institution for the purpose of securely and quickly providing access to funds on demand, through a variety of different channels.

### Communication Interface

A “communication interface” or “communication device” is any device for communicating with other devices or with one or more users. For example, a communication interface may include a modem, server, transceiver, and/or a user interface.

### Computer Program Product

A “computer program product” is an article of manufacture that includes any non-transitory computer readable storage medium having data, code, or other information stored thereon. A computer program product typically includes computer-executable instructions (e.g., code) stored on non-volatile memory. When executed by a processor, such computer-executable instructions typically cause the processor to perform one or more functions.

### Computing Device

A “computing device” is any device that employs a processor and memory and can perform computing functions, such as a personal computer or a mobile device.

### Database

A “database” or “data warehouse” is a computer based storage location composed of data extracted from data processing systems.

### Demand Deposit Account

A “demand deposit account” is a bank account from which deposited funds can be withdrawn on demand without advance notice to the depository institution, such as, for example, general checking and saving accounts.

### Discount

A “discount” is the amount by which the price for a product/service is less than its par or face value of the product/service.

### Entity

An “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity.

### Financial Institution

A “financial institution” is any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like.

### Financial Event or Life Event

A “financial event” or “life event” may be any immediate or future event that causes a change in a user's financial status. A financial event may be a charge, a transaction, and exchange, or the like that may cause the user to lose or gain money and/or assets. Examples of financial events or life events include a medical expense, buying a house, college tuition, rent, and the like.

### Financial Transaction

A “financial transaction” refers to any transaction involving a transfer of money or something of monetary value. For example, a financial transaction may refer to a purchase of goods or services, a return of goods or services, a payment transaction, a credit transaction, a rewards transfer, or an account money transfer or withdrawal.

### Inflow of Funds, Inflows, Incoming Funds

Refers to funds received from or deposited into the user's assets (e.g., user's accounts, or the like), such as paychecks, 401K disbursements, pension disbursements, rental property, or the like.

### Interest

“Interest” is the monetary benefit paid by a borrower for the right to use a lender's or a depositor's funds. In one example, interest may be periodically paid over the life of a loan, deposit, security, or the like. In another example, some interest-bearing instruments, such as savings accounts, may not have defined maturities such that interest is not paid periodically over the life of the instrument but instead is paid solely at the end of the loan/deposit/security term.

### Line of Credit

A “line of credit” is (1) a type of loan that permits a borrower to draw funds, up to a specified maximum, for a defined period of time, or (2) any loan that permits the borrower to borrow funds up to a specified maximum, make repayments in any amount at any time, and obtain any number of advances so long as the maximum is not exceeded. For example, a customer may be issued a revolving line of credit such that the amount borrowed from the line of credit can be paid down and borrowed/advanced again, as the customer's needs change.

### Liabilities

“Liabilities” are cash or cash equivalent debt that a user may owe to an entity. Examples of liabilities may include a home mortgage, another type of loan for which the user has to make payments, taxes owed to the government, a legal judgment against the user, or any other situation in which the use owes a debt to another entity or person.

### Memory

A “memory” or “memory device” is any computer readable medium configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

### Mobile Device

A “mobile device” is any mobile communication device, such as a cellular telecommunications device (i.e., a cell phone or mobile phone), personal digital assistant (PDA), a mobile Internet accessing device, a tablet computer, a laptop, or other mobile device.

### Money Market

A “money market” is an aggregation of buyers and sellers actively trading money market instruments.

### Money Market Deposit Account

A “money market deposit account” is a bank deposit account that pays interest based on the money markets current interest rates. Generally, money market deposit accounts provide higher rate of interest than might otherwise be earned in checking or savings accounts. As compared with demand deposit accounts, money market deposit accounts typically limit the number of transactions in the account within a given time period.

### Monitor

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information.

### Online Banking Account

An “online banking account” is an account that is associated with one or more user accounts at a financial institution and that can be accessed by a user over a network (e.g., the Internet) via a computer device, such as a personal computer, laptop, or mobile device (e.g., a smartphone or tablet). For example, the user may have an online banking account that is associated with the user's checking account, savings account, investment account, and/or credit account at a particular financial institution. A user may access an online banking account to view account balances, view transaction history, view statements, transfer funds, and pay bills. More than one user may have access to the same online banking account.

### Outflow of Funds, Outflows, Outgoing Funds

Refers to funds outgoing from the user's assets (e.g., user's accounts, or the like) to cover liabilities, such as payments for housing (e.g., rent or mortgage), bills, health care insurance and other costs, heat, water, food, car, boat, transportation, or like, which illustrates all of the essential (e.g., necessary or semi-necessary to the user) costs that cover what the user currently uses to live.

### Payment

A “payment” is a monetary amount or item of monetary value transferred from one individual or entity to another individual or entity in return for receipt of good(s) and/or services.

### Processor

A “processor” or “processing device” refers to a device or combination of devices having circuitry used for implementing the communication and/or logic functions of a particular system. For example, the processor may include a digital signal processor device, a microprocessor device, and various analog to digital converters, digital to analog converters, and/or other support circuits. Control and signal processing functions of the system are allocated between these devices according to their respective capabilities. The processor may also include the functionality to encode and interleave messages and data prior to modulation and transmission.

### Retirement Planning

“Retirement planning” in a financial context may refer to the allocation of funds and decisions made for the use of funds incoming and outgoing in an attempt to achieve financial independence, so that the need to be gainfully employed is optional rather than a necessity. “Retirement planning” may relate to anything that involves determining how the user should utilize assets in order to try to maximize the use of the asset to live. In some embodiments, retirement planning models estimate a user's income immediately prior to retirement and adjust this income downward to reflect an income necessary for the user to maintain a satisfactory lifestyle. In some embodiments, a retirement planning model incorporates the user's current health and medical history and extrapolate the annual living expenses through the years in retirement. In some embodiments, retirement planning may be provided to the user by a financial institution, or other entity.

### Transaction

A “transaction” refers to any communication between a user and the financial institution or other entity monitoring the user's activities. For example, a transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like.

### User

A “user” may be a financial institution customer (e.g., an account holder or a person who have an account (e.g., banking account, credit account, or the like)). In one aspect, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably.

### User Interface

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

### A System for Optimizing Fund Usage in Retirement Planning

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution” or “bank,” one of ordinary skill in the art will appreciate that other embodiments of the invention may involve other businesses or institutions that take the place of or work in conjunction with the financial institution or bank to perform one or more of the processes or steps described herein as being performed by a financial institution or bank. Still in other embodiments of the invention the financial institution or bank described herein may be replaced with other types of businesses or institutions that offer account services to users.

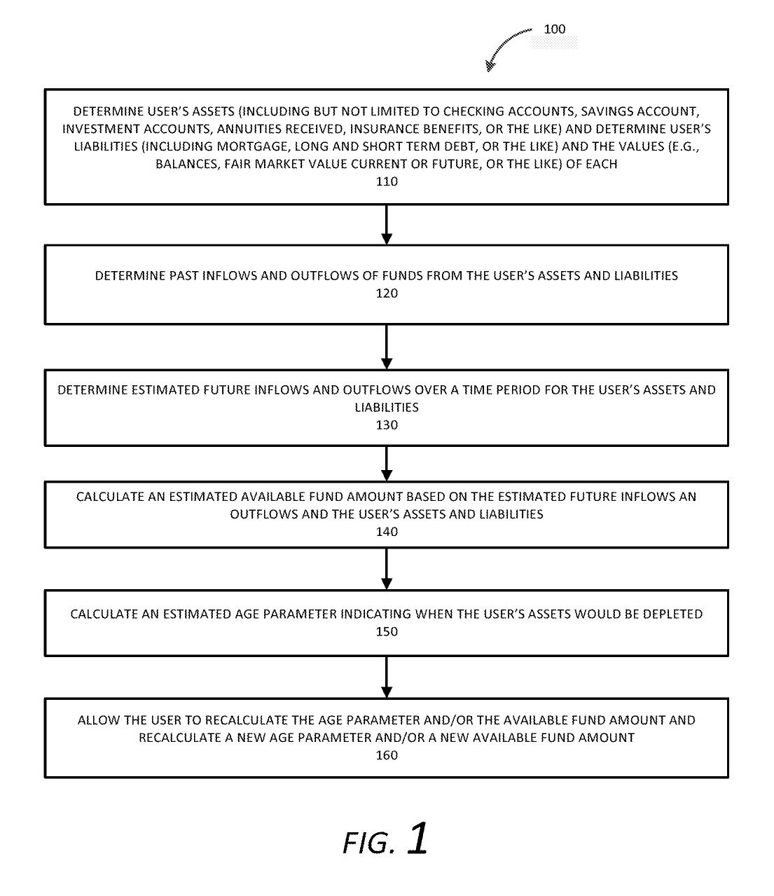

FIG. 1 illustrates a high-level process flow for retirement planning based on fund distributions 100. As illustrated by block 110 of FIG. 1, embodiments of the invention comprise determining a user's assets and the values of the assets (e.g., balances of the account, current or estimated future fair market values of the property, or the like). The user's assets may include but are not limited to checking accounts, savings accounts, investment accounts (e.g., with regular dispersements and penalties for principal withdrawals, or self-directed accounts that more liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash in a couple of days without penalty). Moreover, block 110 of FIG. 1 illustrates that embodiments of the invention further comprise determining a user's liabilities and the values of the liabilities (e.g., amount owed, or the like). The user's liabilities may include a mortgage, long and short term debit, payments owed on other personal property or legal judgments against the user, or the like). In some embodiments all of the assets and liabilities are determined in order to get an idea of what the values of the assets and liabilities are in order to determine how long the inflows and outflows for the user may last.

As illustrated by block 120 in FIG. 1, embodiments of the invention further include determining past inflows of funds received from or deposited into the user's assets (e.g., user's accounts, or the like), such as paychecks, 401K disbursements, pension disbursements, or the like. Block 120 further illustrates that past outflows of funds from the user's assets (e.g., user's accounts, or the like) are determined, such as payments for housing (e.g., rent or mortgage), bills, health care insurance and other costs, heat, water, food, or like, which illustrates all of the essential (e.g., necessary or necessary to the user) costs that cover what the user currently uses to live.

Block 130 of FIG. 1 illustrates that the financial institution determines estimated future inflows and outflows over one or more time periods (e.g., daily, weekly, bi-weekly, monthly, yearly, averages of each, for multiple specific time periods in the future, or the like). The estimated inflows and outflows are based on the user's past inflows and outflows, future scheduled inflows and outflows, the inflows and outflows that the financial may determine will exist in the future, and/or other like estimates. The estimates made for the inflows and outflows by the financial institutions may account for seasonal changes, one time large expenses, knowledge of a change in the user's life, such as moving to a different house, no longer supporting a dependent child, parent, friend, or the like, or any other inflow or outflow that may occur for the user 9.

As illustrated by block 140 in FIG. 1 the estimated available fund amount that the user can spend per period of time may be calculated based on the estimated inflows and outflows from the users assets, such as the user's accounts that provide a distribution of funds to the user and the user's account with which the user pays for expenses. The estimated available fund amount that the user can spend illustrates the amount of money a user can spend above the user's cost of living expenses for entertainment, vacations, gifts, or other like non-essential expenses (e.g., fun money, safe to spend amount, or the like) while maintaining enough funds to reach a certain age (e.g., age parameter at which the user's funds will be depleted and will no longer be able to cover the outflows).

As illustrated by block 150 in FIG. 1, either after, at the same time, or before the estimated available fund amount is calculated an estimated age parameter is calculated that illustrates based on the user's assets, liabilities, estimated inflows, and estimated outflows the age at which the user will run out of funds, or stated another way when the user's outflows are greater than the user's inflows and the user has no additional assets to cover the difference. For example, at the same time the funds from the user's assets are flowing into the user's cash accounts, or other like accounts, the values (e.g., balances) where the fund inflows are coming from are being depleted (e.g., with the exception of annuity type funds such as social security benefits, life annuity payments, pension inflows, or the like). There comes a point in time in which the value of the user's assets (e.g., accounts, assets that the user has mortgaged, or the like) are depleted and the user can no longer cover the outflows.

Block 160 of FIG. 1 illustrates that the user 9 may be allowed to change the available fund amount per the time period (e.g., week, bi-weekly, monthly, six month, yearly, or the like) and/or the age parameter, for example in order to recalculate the available fund amount and/or recalculate the age parameter to identify how long the funds will last based on how much the user 9 wants to spend per the time period, or to identify how much the user 9 can spend based on how long the user 9 wants the funds to last. This information can be controlled and displayed in user interfaces described in further detail later.

It should be understood that when describing a user throughout this invention, the use of the term user may be replaced by users, which indicates that the invention may also include pulling information from the accounts of one or more users (e.g., customers). The multiple users may include a household of people (e.g., husband and wife, parent and child, multiple family members, or the like), which may determine the available funds amount and/or the age parameter for multiple users, for example a household. In still other embodiments, with respect to the actions that a user may take that are described herein, the user may allow or designate another family member, a financial advisor, an estate planner, a trustee, or the like (e.g., otherwise described as a designee) in order to take an action in place of the user. These designees may use the information available to the user for retirement planning purposes during retirement of the user and/or after the user passes away to help plan the user's retirement and/or distribute the user's assets.

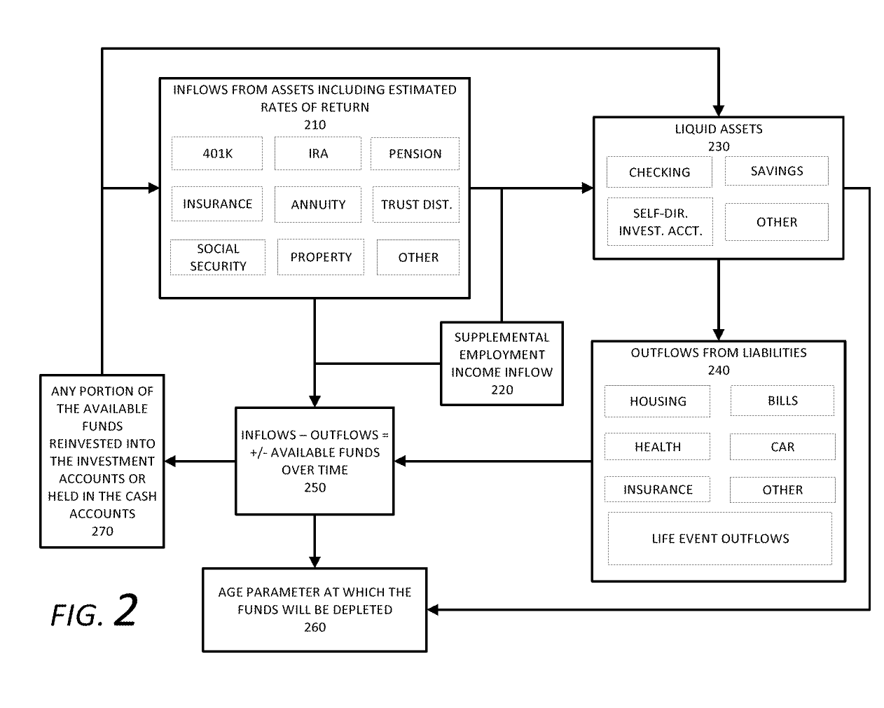

FIG. 2 illustrates a flow chart indicating how the available fund amount and/or an age parameter are influenced, in accordance with one embodiment of the invention. Block 210 illustrates a number of assets, such as types of accounts, investments, annuities, property, or the like that may provide a stream of income (or negative steam of income) or payments over a period of time, but which may also be illiquid or otherwise difficult to convert into cash. For example, types of assets that provide disbursements may be a 401K that requires minimum disbursements to the user 9 over a period of time at a specific age; an IRA that requires minimum disbursements to the user 9 over a period of time at a specific age; a pension account that may provide disbursements until the user 9 passes away; insurance benefits that may be distributed as an annuity for a period of time or as a lump sum; a trust account from which disbursement are made, property that provides rental income to the user 9, social security income or death benefits that pays disbursements for a period of time (e.g., a specific amount of time or for the life of a beneficiary), or other like annuity. In some embodiments of the invention the assets may include estimated rates of returns such that not only are the disbursements used in determining the available fund amount and/or age parameter, but the principal and growth of the principal over time may be used in determining the available fund amount and/or age parameter.

Block 220 illustrates that the user 9 may also have a full-time and/or part time job that provides additional income inflows, such as supplemental employment income inflows, to the user 9 and/or user accounts. The amount of estimated supplemental employment income may be determined based on the hours that the user 9 works, which may be estimated over a period of time, and as such be increased, diminished, or stop based on the age of the user, the number of hours worked over time, increases or decreases in pay over time, and/or other factors that may indicate how long a user 9 may have supplemental income in the future.

As illustrated by block 210 and 220 the inflows from disbursement accounts or other assets, and/or the inflows from supplemental employment income inflow, may be utilized directly to pay for outflows, and thus, be used to calculate the available fund amount illustrated in block 250 described below. In other embodiments of the invention the inflows from disbursement accounts or other assets, and/or the inflows from supplemental employment income inflow may be distributed to liquid or semi-liquid accounts, described in further detail below with respect to block 230.

Block 230 illustrates liquid (e.g., liquid or semi-liquid) assets, such as accounts that may be equivalent to cash or assets that can be converted quickly into cash. For example, the liquid accounts may be checking accounts, savings accounts, self-directed investment accounts, money market accounts, or the like. These liquid accounts may be utilized to pay for the outflows directly as illustrated by block 240 in FIG. 2, which are discussed in further detail later. In some embodiments these types of accounts may be one of the last accounts that may be utilized to pay for outflows after the inflows from block 210 are exhausted (e.g., with the exception of lifetime annuity accounts). Some of these accounts may also have rates of return (e.g., savings accounts, self-directed investment accounts, or the like) which may be factored in when calculating the available fund amount and/or the age parameter.

As illustrated in block 240 the outflows of the users 9 may include the payments that the user 9 makes in order to live (e.g., necessary or semi-necessary to the user for the living expenses and other liabilities of the user 9). For example, in some embodiments the outflows may include housing outflows, which may cover the expenses of the user 9 for mortgage payments, taxes, insurance, or the like that the user 9 has to pay in order to maintain a residence. In other examples, the outflows may be related to bills, such as electric, gas, water, or the like. The user's health care cost, such as user's health care premiums and yearly estimated cost may be included. The user 9 may have car payments that are due on a monthly (or other time period) basis. The user 9 may also have insurance payments for the user's car, life, or the like. In addition, there may be other outflows, such as but not limited to child care payments, cell phone payments, internet, and/or other entertainment expenses that may or may not be included in the outflow calculations (e.g., may or not be considered essentials or semi-essentials). The outflows may also include some life event outflows that may be easily predictable, non-repeating outflows, and/or only periodic outflows (e.g., occurs more than the time period for which the outflows are calculated), such as but not limited to paying for a child's college, paying for a wedding, or other like life events that affect the user's outflows. As illustrated by block 210, 220, and 230 some of these outflows may be paid by one or more of the inflows, the supplemental employment income inflow, and/or the liquid assets either directly or indirectly. As such, one or more of the user's assets may have a balance that is depleted over time as the outflows are paid.

Block 250 illustrates the available fund amount per the time period is determined by taking the difference between the inflows and outflows. As such, the available fund amount illustrates the amount of money that a user 9 has to spend above the user's outflows per the time period. For example, the available fund amount may be utilized by the user 9 to spend on trips, electronics, entertainment (e.g., dinners, moves, shows, or the like), to spend on family members, or the like. The available fund amount is the amount of money that the user 9 is safe to spend over the time period, without spending negative amounts of money on the outflows.

As illustrated by block 260, the available fund amount may be utilized, along with the user's assets and liabilities, in order to determine an age parameter at which the user's assets are estimated to be depleted. As such, the age parameter illustrates the age at which the user 9 will not be able to cover the outflows. For example, as the user's inflows from block 210 are depleted, there becomes a point in time when the user's inflows will not cover the user's outflows. At this point in time, the outflows will be covered by the balances of the user's liquid assets (e.g., cash accounts or other like cash accounts). As such, a calculation for an age parameter may be made when the total assets of the user (e.g., inflows from assets and liquid asset accounts) would not cover the outflows for the user's liabilities. In some embodiments the age parameter may be infinity as the user's inflows are so great (e.g., payments received in dividends, interest rates, rental payments received) that they will never be depleted enough to be less than the user's outflows.

Block 270 illustrates that in some embodiments the user 9 may not spend the available fund amount, and as such depending on the how the outflows were paid, the unspent fund amount may be reinvested into the liquid assets (e.g., self-directed accounts, checking accounts, savings accounts, or the like) or back into more illiquid assets, such as purchases of property or other non-liquid assets.

It should be understood that the determination of the available fund amounts over the time period and/or the age parameter may change in real-time or near real-time as the rate of return on the assets change (e.g., stock values change, rental income changes or goes away, assets are depleted, big purchases are made or sold, or the like), and costs of the liabilities change (e.g., damage to property than needs repair, variable interest rate changes, life events occur that deplete assets, loans are taken out or paid off, or the like). As such, the present invention may be constantly in real-time or near real time, or over various intervals, recalculated in order to provide a more accurate available fund amount and/or age parameter to the user 9, such that the user 9 is better able to plan for retirement. Moreover, as illustrated in further detail later the user 9 may be able to adjust the available fund amount and/or the age parameter in order to determine how changes in spending habits affect the age at which the user's assets are depleted, or vice versa.

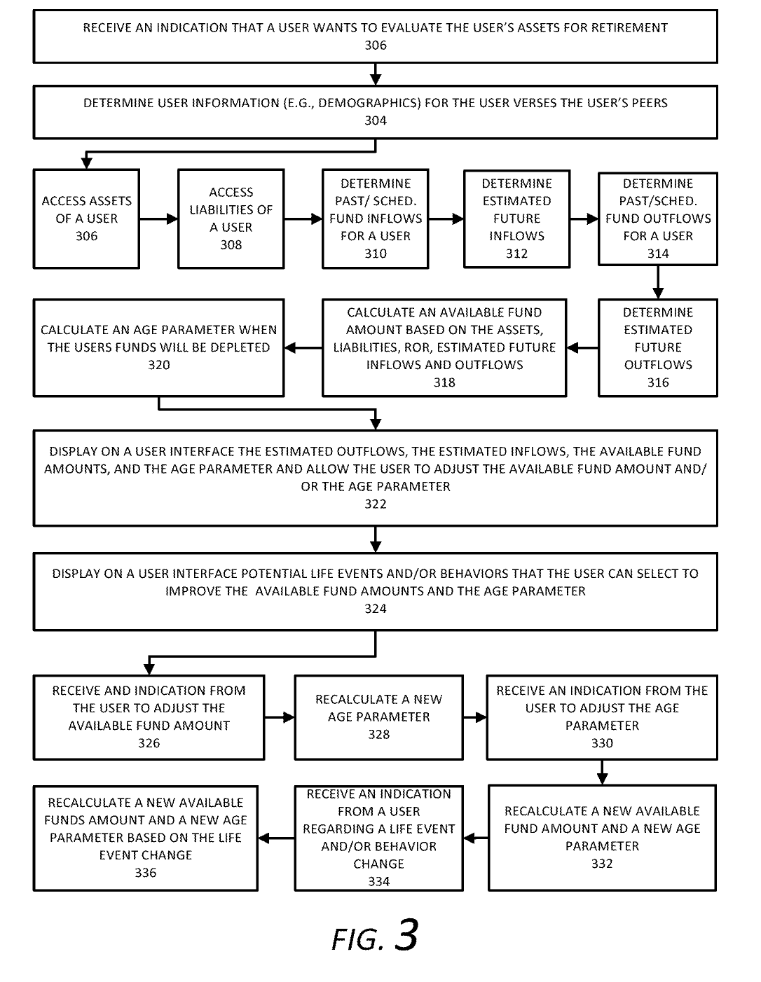

FIG. 3, illustrates a detailed process flow for retirement planning based on fund distributions. As illustrated by block 302, the financial institution receives an indication that a customer (e.g., a type of user 9) wants to evaluate the customer's assets for retirement. For example, the customer may access a retirement planning interface (e.g., described in further detail later) and requests that the financial institution evaluates the customer's retirement assets and liabilities.

As illustrated by block 304, the financial institution may access user information for the user, such as not but not limited to the user's age, lifestyle, geographic location, health history (e.g., through medical expenses, food purchases, or information disclosed by the user 9), and thereafter determine the same and/or average peer information for similar users of the same age, demographic location, health history, or the like and use the average statistics to determine the life expectancy of the user's peers, the estimated inflows and estimated outflows of the user's peers, and/or the average assets and liabilities, and rates of return on each, of the user's peers. This information may be utilized, in part, in order to estimate the future inflows, outflows, assets, liabilities, rates of return, or the like.

Block 306 illustrates that the financial institution accesses the assets of the customer (e.g., the assets described with respect to blocks 210 and 230 in FIG. 2). For example, the financial institution accesses asset information from the customer's accounts that the financial institution services. The customer may also allow the financial institution to access the customer's accounts with other third-parties and/or financial institutions. Moreover, the financial institution may evaluate other assets that the financial institution knows that the customer owns, such as for example the financial institution has information about the property that the customer's own, and thus can evaluate the value of the asset and/or the future value over of the asset over time.

FIG. 3 also illustrates in block 308 that the financial institution accesses the liabilities of the customer (e.g., the liabilities described with respect to block 240 in FIG. 2). For example, the financial institution accesses liability information from the customer's accounts that the financial institution services. The customer may also allow the financial institution to access the customer's accounts with other third-party financial institutions (e.g., first mortgage, second mortgage, or the like). As such, the financial institution may evaluate the liabilities that the customer has that may affect the retirement planning of the customer.

It should be understood that with respect to blocks 306 and 308, as well as otherwise described herein, in some embodiments of the invention the current and/or future fair market value of the assets or liabilities may be determined by accessing third-party servers, systems, devices, applications, or the like in order to determine the fair market values. For example, the financial institution may access websites that provide estimates of home values, car values, antique values, or the like.

Block 310 illustrates that the financial institution determines the past/future fund inflows for the customer. For example, the financial institution can determine the amount of funds that the customer has received from various accounts within and outside of the financial institution over time. With respect to the accounts serviced by the financial institution the financial institution has access to the past/future fund inflows. With respect to accounts located outside the financial institution the past fund inflows may be determined by identifying the inflow of funds into the accounts held by the financial institution. Moreover, as previously discussed the customer may allow the financial institution to access the customer's accounts to determine any past/future funds that the customer may receive from various assets. Moreover, the financial institution may determine the assets of the customer that have yet to provide inflows (e.g., 401k accounts that cannot be accessed until a specific age, or the like). In some embodiments the financial institution may estimate the future inflow of funds, for example, if the customer receives the same payments continuously in consecutive time periods the financial institution may continue to estimate the same fund receipts in future time periods.

In some embodiments, the customer (e.g., user 9) may have assets that only the customer is aware of, and as such the customer may provide an indication of the unidentified assets to the financial institution to include in the financial institution's calculation of the user's assets and/or fund in-flows. In some embodiments the unidentified assets may include money being paid back for a loan provided by the customer that the financial institution does know about, the customer is a beneficiary of an account that the financial institution does not know about, the customer is a silent partner in business that the financial institution does not know about, or the like.

In some embodiments, the financial institution may analyze the outflows in order to determine what may qualify as an outflow that is necessary (e.g., necessary or semi-necessary to cover cost of living expenses), such as mortgages, heat, water, gas, phone, internet, or the like, from any discretionary spending that may cover payments the user 9 may make for entertainment (e.g., trips, dinner out, movies, shows, presents, or the like), such as payments that would be covered by the calculated available fund amount. As such, the transactions made by the user 9 that may be discretionary may be utilized to determine an estimated available fund amount that the user 9 is currently spending, which may be augmented by inflation rates in order to determine what the available fund amount may be in the future. As such, the available fund amount may be set in order to determine what the user likely wants to have available to the user 9 in the future, and which may be utilized to determine the age parameter.

Block 312 illustrates that the financial institution determines the estimated future inflows that the customer receives based on the past inflows and future inflows determined from block 310. The financial institution may determine the estimated inflows that the customer may receive (e.g., may decide to receive, may be required to receive based on applicable laws, or the like) in the future. The estimated inflows may be averaged over a one or more time periods (e.g., short term, long term, or the like), may be determined for one or more time periods, or may be determine until reaching the age parameter.

Block 314 illustrates that the financial institution determines the past/future fund outflows for the customer. For example, the financial institution can determine the amount of funds that customer has paid from various accounts within and outside of the financial institution over time. With respect to the accounts serviced by the financial institution the financial institution has access to the past/future fund outflows by examining the payments that the customer has made over time (e.g., in the past) and/or has scheduled in the future. In some embodiments the financial institution may estimate the future outflow of funds, for example, if the customer makes the same payments continuously in consecutive time periods the financial institution may continue to estimate the same payment in future time periods. For example, the financial institution can determine the amount of funds that the customer has sent for payment from various accounts within and outside of the financial institution over time. With respect to accounts located outside the financial institution the past fund outflows may be determined by identifying the outflow of funds from the accounts held by the customer at outside financial institution that are received by the financial institution. Moreover, as previously discussed the customer may allow the financial institution to access the customer's accounts at the outside financial institutions to determine any past/future funds that the customer may have sent from various assets. Moreover, the financial institution may determine the liabilities of the customer that have yet to provide outflows (e.g., annuity payments that the customer may make in the future, payments scheduled for a trust account, payments to fund a future asset purchase, or the like). In some embodiments the financial institution may estimate the future outflow of funds, for example, if the customer makes the same payments continuously in consecutive time periods the financial institution may continue to estimate the same payments in future time periods.

In some embodiments, the customer (e.g., user 9) may have liabilities that only the customer is aware of, and as such the customer may provide an indication of the unidentified liabilities to the financial institution to include in the financial institution's calculation of the user's liabilities and/or fund out-flows. In some embodiments the unidentified liabilities may include money the customer is paying back for a loan provided to the customer (e.g., loan from a family member or friend, or the like) that the financial institution does know about, the customer is supporting a dependent that the financial institution does not know about, the customer is a silent partner in business that the financial institution does not know about, or the like.

Block 316 illustrates that the financial institution determines the estimated future outflows that the customer pays based on the past outflows and future outflows determined from block 314. The financial institution may determine the estimated outflows that the customer may pay (e.g., may decide to pay, may be required to pay based on applicable laws, payments made to cover liabilities, or the like) in the future. The estimated outflows may be averaged over a one or more time periods (e.g., short term, long term, or the like), may be determined for one or more time periods, or may be determine until reaching the age parameter.

The financial institution may calculate an available fund amount based on the estimated future inflows and outflows, as illustrated by block 318. For example, the financial institution may determine the current available fund amount based on the current inflows and outflows for the current time period, the estimated future available fund amount based on the estimated future inflows and outflows for any time period in the future, or an average available fund amount based on the average inflows and outflows for multiple time periods. As discussed, in some embodiments the available fund amount may be an average available fund amount over multiple periods of time, a specific estimated available fund amount for a specific future time period, and specific average available fund amount for a specific future time periods, an estimated range of the available fund amount for one or more time periods, or any other current or future available fund amount for any time period or time period range (e.g., seasonal, yearly, monthly, or the like).

As illustrated by block 320 the financial institution calculates an age parameter that is based on the estimated inflows, estimated outflows, and the customer's assets and liabilities. For example, the financial institution (e.g., through the retirement planning systems 10 and/or the retirement planning application 17) uses the customer's current age, calculates how the inflows will deplete the user's assets over time, calculates how the outflows will be paid using the user's assets (e.g., illiquid assets and/or liquid assets), calculates when the outflows exceed the inflows and the user's liquid assets or illiquid assets have to be sold to cover the outflows, and when the funds from all of the user's assets are depleted such that the customer cannot cover the outflows, and finally the financial institution calculates the point in time when the user's assets are depleted and determines the age of the customer at this point in time. In some embodiments, the financial institution not only calculates the age parameter when the assets of the customer are depleted, but also calculates the time at which the customer's liquid assets may have to be sold. For example, if the user owns rental property and the customer's inflows have been depleted to a point in which the inflows and/or liquid assets no longer would cover the outflow, the financial institution may determine that age at which the user needs to sell the property in order to cover the outflows. In other embodiments, this may apply to other illiquid assets, such as but not limited to cars, boats, annuity payments that can be sold for a lump sum, or the like.

Moreover, in other embodiments of the invention if the customer has lifetime annuities, and/or inflows, the financial institution may also determine the point at which a customer must reduce the user's outflows in order to allow the customer's inflows to cover the customer's outflows. For example, the financial institution may determine the age parameter at which the customer's inflows and assets will no longer cover the customer's outflows. At this lifestyle change age parameter the customer may still have inflows from lifetime benefits (e.g., lifetime annuities, lifetime pensions, or the like), but such inflows may not cover the customer's outflows. As such, the customer may continue to live off of the inflows, but the customer may have to change his/her outflows. For example, the customer may be required to sells the customer's home and move to a less expensive home or rental property, in addition the customer may also have to reduce other types of expenses as well. In this way, the financial institution may also determine a new reduced available fund amount on which the customer can now live on based on lifetime annuities and the customers reduced outflow expenses. In some embodiments the new age parameter may also be extended based on the reduced outflows, or even extended indefinitely because of the lifetime inflows.

As illustrated in block 322 the financial institution (e.g., through the retirement planning systems and/or the retirement planning application 17) may display the information discussed in blocks 302 to 320 in one or more interfaces, such as a retirement planning interface 400 and/or an available fund amount interface 500. The interfaces, as discussed in further detail later, may include the current and/or estimated outflows and/or inflows, the current and/or future estimated available fund amounts, and/or the estimated age parameter, and any depleted available fund amount and/or depleted age parameter calculated from lifetime inflows, as well as any averages for one or more time periods for any of these calculations.

In addition, as discussed in further detail later, block 324 illustrates that the financial institution also displays in the one or more interfaces potential life events that the customer may select to improve the estimated available fund amount and/or the age parameter. For example, life events that are certain to occur, or have a chance of occurring, may change the assets or liabilities and/or the inflows or outflows of the customer, and may be utilized to adjust the available fund amount and/or the age parameter in order to provide more accurate retirement planning. In addition to the life events, the present invention may also allow the user to input specific behaviors that the user takes in order to see how the behaviors affect the user's age parameter or available funds amount. The behaviors may be daily, weekly, monthly or other like behaviors (e.g., transactions, purchases, savings strategies, investment strategies, or the like), which the user 9 may currently make or the user may want to make in the future. By selecting the behaviors the user 9 can determine how cutting out the behavior or adding the behavior may change the available fund amount and/or the age parameter.

Block 326 illustrates the financial institution (e.g., through the retirement planning systems 10, the retirement planning application 17, and/or the interfaces 400, 500 discussed in further detail later) receives an indication from the customer to adjust the available fund amount. As illustrated by block 328, and discussed in further detail later with respect to the interfaces 400, 500 the financial institution (e.g., through the retirement planning systems 10 and/or the retirement planning application 17) recalculates a new age parameter and displays it in the interfaces 400, 500.

Block 330 illustrates that the financial institution (e.g., through the retirement planning systems 10, the retirement planning application 17, and/or the interfaces 400 discussed in further detail later) receives an indication from the customer to adjust the age parameter. As illustrated by block 332, and discussed in further detail later with respect to the interfaces 400, 500 the financial institution (e.g., through the retirement planning systems 10 and/or the retirement planning application 17) recalculates a new available fund amount and displays it in the interfaces 400, 500.

In some embodiments of the invention the life event may include a medical expense, a child moving back home or leaving home, the death of a spouse, inheritance, unexpected income, a trip to plan, or other like major life event that may occur. The user 9 may select one of the life events, and the financial institution may provide cost estimates for the life events automatically based on the experience of the financial institution systems that track similar life events for other users. Alternatively, the user 9 may add specific costs associated with the life event in order to determine how the life event will affect the available funds amount and/or the age parameter.

In some embodiments of the invention the behaviors may include transactions that the user 9 is thinking about adding or removing from the user's outflows or from using the available funds on. For example, the user 9 may select a behavior in order to determine the cost savings if the user 9 decides to cut out the transaction. For example, the user 9 may cut out a five (5) dollar cup of a coffee that the user purchases 5 days a week. The user 9 may input the cost information, and in response the financial institution may determine how the cost of the transaction (e.g., coffee) would increase based on inflation in the future and determine how much money the user would save if the user cut out the transaction (e.g., coffee) altogether, or replaced it with a less expensive alternative behavior (e.g., cost of tea, water, making coffee at home, or the like). The financial institution may determine the alternative behavior and the cost of the alternative behavior through transactions of other users that the financial institution has access to. The age parameter and the available funds amount are recalculated to illustrate how the change in the behavior affects the retirement planning. In another example, the user 9 may decide that he is going to start buying movie channels through the user's cable package. The financial institution may estimate the additional cost outflow of the change and provide an indication how the additional costs over time would affect the user's available fund amount and/or the user's age parameter.

The financial institution may store information related to the costs of specific behaviors based on transaction information from the financial institution's customers (e.g., the financial institution knows the average cost of the behavior, or the cost of the behavior for a peer of the user). In other embodiments, the financial institution may be able to access this type cost information from third-parties (e.g., the third-parties know the average cost of the behavior, or the cost of the behavior for a peer of the user). In still other embodiments of the invention, the user 9 may provide the cost information related to the behavior (e.g., the user may input the cost into the retirement planning interface). The financial institution may determine how the costs might change over time based on inflation information, changes in the frequency of the behavior (e.g., as the person ages the person may perform the behavior more or less), estimated changes of the cost of the behavior vs. other behaviors over time (e.g., cost of the behavior decreases vs. inflation), or the like.

Block 334 illustrates that the financial institution (e.g., through the retirement planning systems 10, the retirement planning application 17, and/or the interfaces 400 discussed in further detail later) receives an indication from the customer to add a life event to adjust the retirement planning. As illustrated by block 336, and discussed in further detail later with respect to the interfaces 400, 500 the financial institution (e.g., through the retirement planning systems 10 and/or the retirement planning application 17) recalculates a new available fund amount and a new age parameter and displays it in the interfaces 400, 500.

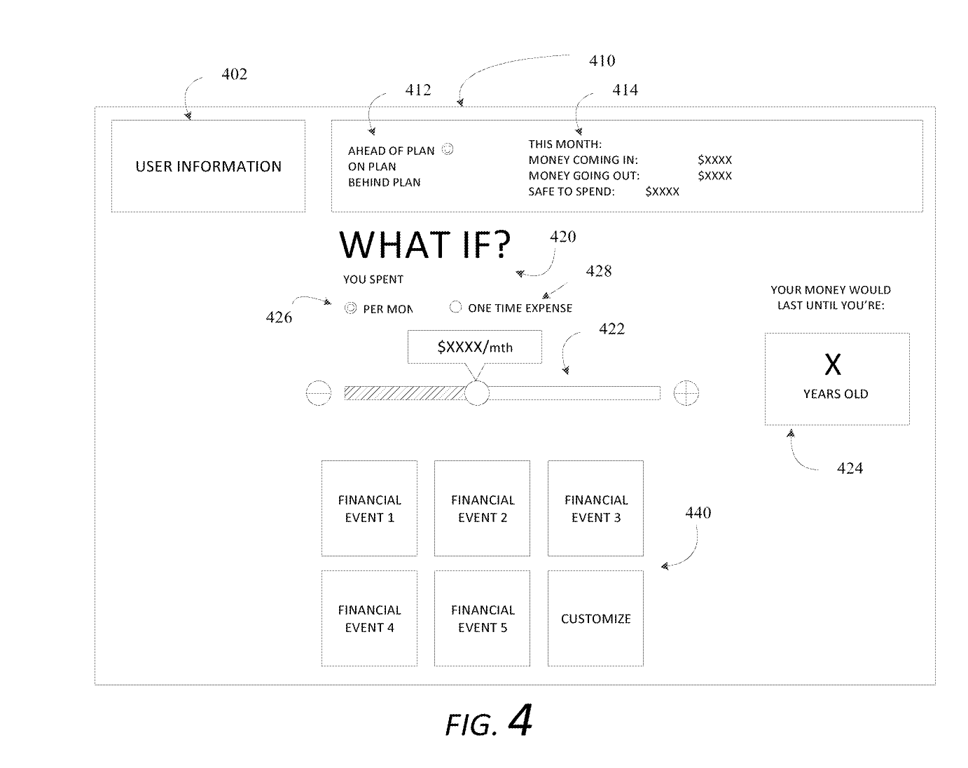

FIG. 4 illustrates a retirement interface 400, which in one embodiment illustrates user information 402 (e.g., customer information) related to the name of the user, profile picture, demographic information, or the like. The retirement interface 400 may also comprises a plan summary section 410, which may illustrate a plan status section 412 and a plan fund summary 414. The plan status section 412 may include an indication if the user is currently ahead of the desired retirement plan, on pace with the desired retirement plan, or behind the desired retirement plan (e.g., user retirement plan goals). For example, in some embodiments the user 9 may select a particular desired available fund amount that the user 9 would like to spend over a period of time (e.g., monthly) the user may also select a desired age parameter for which the user 9 would like the user's funds to last. After the financial institution determines the user's estimated available fund amount and estimated age parameter the financial institution (e.g., the retirement planning systems 10 and/or the retirement planning application 17), through the retirement planning interface 400, may display and indication whether or not the desired available fund amount and/or the desired age parameter meets the estimated available fund amount and/or the estimated age parameter in the plan status section 412. The plan fund summary section 414 may illustrate the user's current or estimated future fund inflows, fund outflows, and the available fund amount (e.g., safe to spend amount) that the use may spend on top of meeting the user's expenses. For example, the available fund amount in the plan fund summary section 414 may display what the user's current available fund amount is for the current time period (e.g., the current month). In other embodiments, the plan fund summary section 414 may illustrate an available fund amount for a future time period. For example, since these numbers may change over time because the user's inflows, outflows, and rates of return on the assets and liabilities will change over time, the user 9 may select a future time period for which the user would like to see a summary in the plan fund summary section 414. The selection of the future time period may occur through a calendar selection, a drop down list section, search selection, or the like. Regardless of the selection, the plan summary section 414 may illustrate estimates of the future inflows, future outflows, and the available fund amount for one or more future time periods selected by the user. In other embodiments the financial institution may select the one or more future time periods to display to the user 9. For example, the financial institution may decide elect to illustrate the seasonal changes in the future inflows, future outflows, and the available fund amount (e.g., changes between the fall, winter, spring, and summer); may elect to illustrate yearly changes in the future inflows, future outflows, and the available fund amount (e.g., averages for each year in the future and estimated changes in the averages, or estimates at the beginning, middle, and/or end for each year); may elect to illustrate whenever there is a change in the future inflows, future outflows, and the available fund amount (e.g., only display the estimates when the estimates change, such as one estimate for the first six months, estimates for the next two months when they change, etc.); or any other patterns in displaying the future inflows, future outflows, and the available fund amount.

The retirement planning interface 400 may also illustrate a financial planning estimator section 420, which may include an available fund amount estimator section 422 and an age parameter estimator section 424. The available fund amount and age parameter initially provided in the available fund amount estimator section 422 and the age parameter estimator section 424 may be the initial values determined by the financial institution, as previously described herein. The available fund amount estimator section 422 may allow a user 9 to identify the impact on the user's retirement plan by changing the available fund amount per a time period (e.g., the user may select a per month selection feature 426), or identifying the impact of a one-time expense (e.g., the user may select a one-time expense selection feature 428). With respect to the changing the available fund amount per a time period the user may utilize an available fund amount selector (e.g., the slide feature illustrated in FIG. 4, a blank input, drop-down menu, or any other like selector) to change the estimated available fund amount to illustrate how changing the spending amount affects the calculation of the age parameter illustrated in the age parameter estimator section 424. For example, decreasing the available fund amount the user 9 spends may increase the age parameter, while increasing the available fund amount the user 9 spend may decrease the age parameter. The change may be linear or non-linear in that small changes vs. large changes in the available fund amount may result in expediential changes in the age parameter due to the time value of money, the return on investment rate over time, the age of the user, the value of the assets and liabilities, or the like.

In other embodiments of the invention, the user 9 may change the age parameter (e.g., decrease or increase the age parameter by 1, 5, 10, or like years) in the age parameter estimator section 424 and the available fund estimator section 422 changes the available fund amount that the user may have to spend over a time period (e.g., on average for a range of time periods, a particular time period, and/or multiple time periods). In some embodiments when the user 9 changes the available fund amount and/or the age parameter the plan summary section 410 may also update based on the new estimates, and display different estimates over one or more time periods based on the changes made by the user 9 to the available fund amount and/or the age parameter.

The same changes may be illustrated in the retirement planning interface 400 if the user estimates a one-time expense. For example, if the user selects the one-time selection feature 428, a one-time expense section may be presented to the user 9 (not illustrated). The user 9 may enter the value of the one-time expense in the one-time expense section. For example, the user 9 may be purchasing a car, house, boat, furniture, or another type of one-time expense. The user 9 may input in estimated one-time expense, and as such the financial institution (e.g., the retirement planning system and/or the retirement planning application 17) may factor in the reduction of the user's assets (e.g., reduction in the amount in a cash account, reduction in the amount of a retirement asset, outflows based on additional liability for a loan and/or lease to pay for the one-time purchase, or the like) and calculate new estimated available fund amount and/or estimated age parameter. The retirement planning summary section 410 may also be updated based on the one-time expense. As such, the user 9 may be able to factor in how a potential one-time expense will affect the user's retirement plan.

The retirement planning interface 400 also has a life event section 440, which illustrates some life events that may affect the user's future retirement plan. Some life events may include a potential medical expense, a child or parent that the user 9 is tasked with supporting, a death of a spouse or dependent, an inheritance, unexpected income, a trip, a move to another area, or other like life event. In some embodiments, the user 9 may select one or more of these life events, in order to factor in one or more of the life events into the user's retirement plan. The financial institution (e.g., through the retirement planning systems 10 and/or the retirement planning application 17) may access external services and/or internal databases in order to determine how much such a life event may cost. For example, in some embodiments the user 9 might select a medical expense and specify a particular type of medical issue, such as a knee replacement. Continuing with the example, the financial institution (e.g., through the retirement planning systems 10 and/or the retirement planning application 17) may access medical institutions, insurance institutions, and/or medical payments in order to determine how much a knee replacement typically costs. In some embodiments, the user 9 and/or the financial institution may factor in how much would be paid by insurance and how much would come out of the user's assets. Furthermore, the financial institution (e.g., through the retirement planning systems 10 and/or the retirement planning application 17) may access the user's assets to determine from which accounts the medical expenses should be paid. With respect to having to support a child or parent the financial institution may access internal or external services that have applications which indicate the estimated costs for supporting a child moving back in with his parents or support a dependent parent based on the dependent parent's age and medical condition. In still other embodiments, with respect to the death of a spouse the financial institution my adjust the assets, liabilities, inflows, and outflows in order to determine new estimated available fund amounts and age parameters. In other embodiments the financial institution (e.g., through the retirement planning systems 10 and/or the retirement planning application 17) may factor in an inheritance that the user 9 may receive in the future (e.g., actual inheritance, or an estimated inheritance), may factor in unexpected income from a part time job, lotto winnings, or the like. In other embodiments the financial institution (e.g., through the retirement planning systems 10 and/or the retirement planning application 17) may factor in expenses, such as a trip, payment to a dependent, setting up a trust account, or the like which may all affect the user's financial planning. As such the financial institution (e.g., through the retirement planning systems 10 and/or the retirement planning application 17) may recalculate the inflows, outflows, the available fund amount, and/or the age parameter based on the life events.

In some embodiments of the invention a custom life event that is not specifically presented to the user 9 by the financial institution in the retirement planning interface 400 may be added by the user 9, which may include adding the type of life event, as well as the associated costs of the life event and the costs that may be attributable to user 9. The financial institutions (e.g., through the retirement planning systems 10 and/or the retirement planning application 17) may recalculate the inflows, outflows, the available fund amount, and/or the age parameter based on the life event added by the user.

In some embodiments of the invention, in addition to selecting a life event or adding a custom life event the user 9 may indicate the likelihood of the occurrence of the life event, such as percentage which the financial institution (e.g., through the retirement planning systems 10 and/or the retirement planning application 17) may use to discount the benefit or cost of the associated with the life event. For example, the user 9 may estimate that a medical expense is only 50% likely to occur, and as such the financial institution may reduce the affect that the medical expense has on the inflows, outflows, the available fund amount, and/or the age parameter when compared to if the medical expense was 100% certainty. This likelihood of occurrence factor may be applied to any life event selected or custom life event added by the user 9.

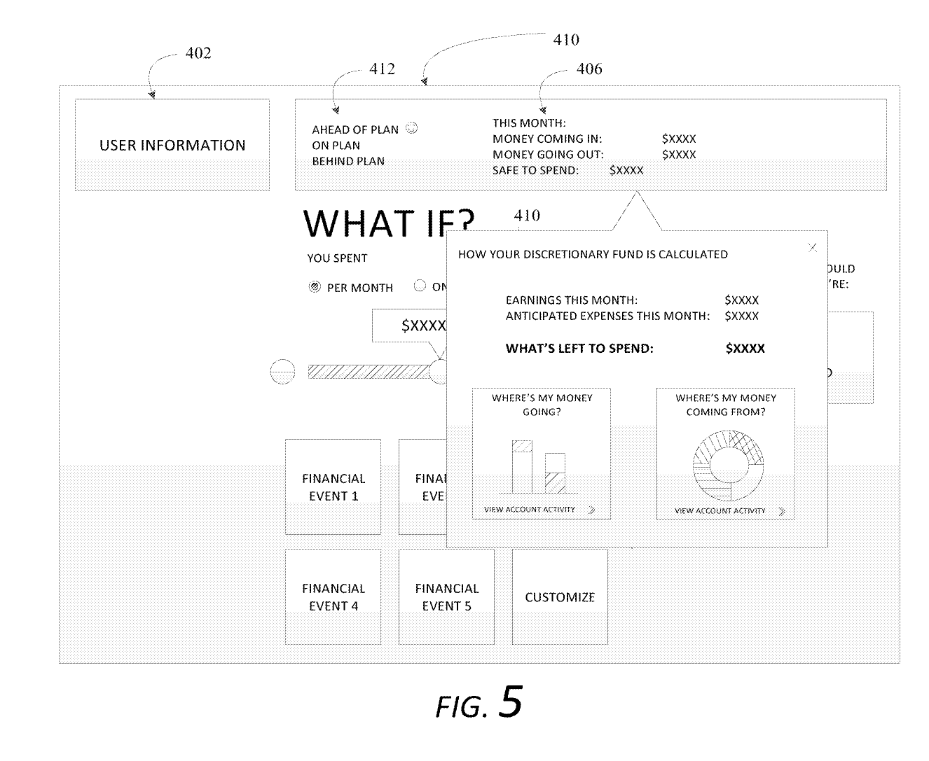

FIG. 5 illustrates another embodiment of the invention, in which additional information is presented to the user 9 regarding how the available fund amount is being determined. In some embodiments, an available fund amount interface 500 may be presented to the user 9, for example in a pop-window as illustrated in FIG. 5, or in other embodiments another type of interface. The available fund amount interface 500 may include information regarding how the user's available fund amount is determined. In one embodiment, as illustrated in FIG. 5 the available fund amount interface 500 may illustrate an inflow section 510 (e.g., inflow list, graph, table, or the like) that illustrates from where the inflows are being received and the amount of each of the inflows for a time period selected by the user or presented by the financial institution. The available fund amount interface 500 may also include an outflow section 520 (e.g., outflow list, graph, table, or the like) that illustrates from where the outflows are being received and the amount of each of the outflows for the time period selected by the user or presented by the financial institution. In still other embodiments inflow links 512 and outflow links 522 in the interface may be selected by the user 9 in order to take the user 9 to an activity list illustrating all of the user's inflow and outflow for a particular time period.

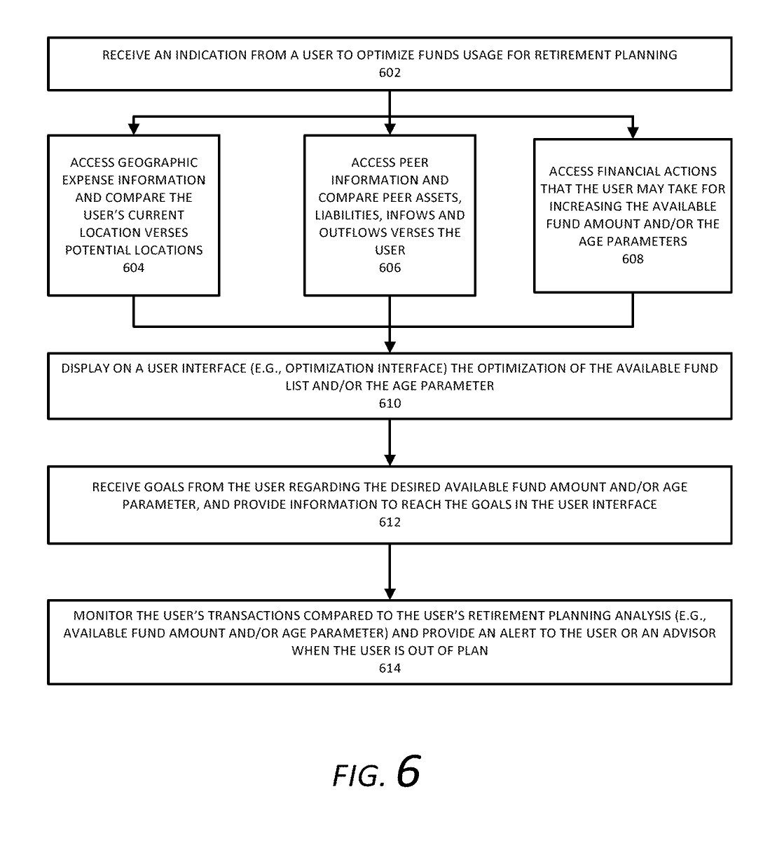

FIG. 6 illustrates an optimization and goal process 600 for optimizing the user's retirement planning and/or for achieving the retirement goals of the user 9. As illustrated by block 602 the financial institution receives an indication from a user to optimize the retirement planning of the user 9, such as an indication received from user through the retirement planning interface 400 previously described. For example, in one embodiment of the invention the user 9 may not like the calculation that the financial institution made with respect to the available fund amount and/or the age parameter, and as such, the user 9 may want to receive information related how to optimize (e.g., improve, increase, or the like) the available fund amount and/or the age parameter.

In one embodiment, as illustrated by block 604 the user 9 may request to optimize the available fund amount and/or the age parameter through one type of optimization parameter, which may comprises determining another location to which the user 9 may move to extend the time for which the user's funds may last (e.g., and optimized location parameter). In one embodiment of the invention, as illustrated in block 604 the financial institution may access the user's accounts to determine locations in which the user 9 has made transactions in order to determine one or more locations (e.g., one or more geographic regions, states, counties, cities, towns, developments, or the like) that the user 9 has visited, and as such, may have family, friends, may like to visit, or the like. In one embodiment, the financial institution may identify where the user's cars are registered to determine a new location. In other embodiments, the financial institution may identify the beneficiaries of the user 9 and where the beneficiaries live (e.g. through transaction information, listed addresses, or the like). In still other embodiments, the financial institution may determine where the user 9 pays state income tax in order to determine a new location for the user 9. In other embodiments of the invention, the financial institution may identify one or more locations that the financial institution may suggest, or may have suggested in the past, which may have lower cost of living expenses than the user's current location. In still another embodiment, the user 9 may select a new location to which the user 9 is interested in moving, and the financial institution may provide information related to the changes in the available fund amount and age parameter based on the requested location selected by the user 9. The financial institution may have access to, or may access third-party websites in order to determine, the cost of living in the locations (e.g., current user location and one or more potential new locations). The financial institution may compare the cost of living of the current user location with the cost of loving of the one or more potential new locations, and identify one or more new locations to which the user 9 could relocate to reduce the user's outflows. The financial institution may recalculate the available fund amount and age parameter using the cost of living expenses (e.g., housing, food, heating, cooling, television, phone, property taxes, gas, or the like) for the one or more new locations, in order to determine a location specific optimized available fund amount and an a location specific optimized age parameter. The financial institution may display the location specific optimized available fund amounts and location specific optimized age parameters for the one or more new locations verses the user's available fund amount and age parameter for the user's current location in the retirement planning interface 400.

In another embodiment of the invention, as illustrated by block 606, the user 9 may request to optimize the available fund amount and/or the age parameter through one type of optimization parameter, which may be based on investment decisions, inflow decisions, and/or outflow decisions of peers of the user 9 (e.g., peer optimization). As previously discussed, peers may include people that have similar peer information as the user information of the user 9. For example, the user information and peer information may include but is not limited to the age, lifestyle (e.g., based on transactions), geographic location, health history, investment risk, transactions, interests, products (e.g., goods and services) purchased, or the like of the user and the user's peers. For example, the financial institution may have access to the peer information because the peers are also customers of the financial institution, or may pull general information from third-parties. As such, the financial institution may identify one or more peers (e.g., specific or anonymous people, or specific or anonymous groups of people) of the user 9 and analyze the fund-inflows and fund-outflows of the peers, and/or the available fund amount and/or age parameter of the peers compared to the same information of the user 9. In other embodiments of the invention the financial institution may compare goals of the user 9 with the goals of peers (e.g., explained in further detail later). The financial institution may identify peer decisions, for example investment decisions, investment risk, purchases, geographic locations for living, types of housing, inflows, outflows, or other transactions, or the like associated with the peers. The financial institution determines how the user 9 may adjust the user's decisions with respect to the user's assets, liabilities, inflows, outflows, or the like to improve upon the available fund amount, the age parameter, and/or the retirement planning of the user 9 based on the user's decisions. For example, if the user's peers are invested in assets with a guaranteed return of 4% and are less risky, while the user is invested in assets that may result in estimated returns of negative 8% to positive 8%, the financial institution may suggest different investments for the user 9. As an example, the financial institution may suggest to the user to investing less risky assets. Moreover, the financial institution may determine that the user's peers spend less on housing and food than the user 9. As such, the financial institution may provide suggestions to the user to reduce the user's housings and food costs. In other example, the financial institution may also identify the assets the user's peers use to pay for expenses during different year, and as such may suggest to the user 9 specific accounts and amounts from the accounts that the user 9 should use to cover the user's transactions. Moreover, in addition to the suggest tips, the financial institution may provide an updated available fund amount and/or age parameter based on the suggested user decisions determined from the decisions of the user's peers. In other embodiments of the invention, the financial institution may provide other types of suggestions for the user based on the actions of the user's peers.

In another embodiment of the invention, as illustrated by block 608, the user 9 may request to optimize the available fund amount and/or the age parameter through one type of optimization parameter, which may be based on products (e.g., services, or the like) that the financial institution or another third-party (e.g., other financial institution) may provide to the user 9 to increase the user's assets and/or fund-inflows and decrease the user's liabilities and/or fund-outflows (e.g., financial product optimization). The financial institution may extend, or find another third-party to extend, available loans, re-financing, asset distribution (e.g., taking distributions based on reducing tax savings), asset to cash conversion (e.g., selling property, converting stocks that are declining into cash, or the like), cash to investment conversion (e.g., purchase bonds, mutual funds, high yield dividend stocks, or the like with idle cash), or the like. The financial institution may evaluate the user's assets and liabilities in order to determine products that the financial institution (or other third-party) may offer the user 9. For example, the financial institution may identify that the user's mortgage rate is high and the user 9 may be able to save funds by refinancing. In other embodiments, the financial institution may be able to provide a mortgage to the user at a low interest rate (e.g., 3.5%) and invest the funds for the user 9 in a stock that has a 5% dividend. In still other embodiments of the invention, the financial institution may indicate to the user 9 that the user should convert the user's idle cash to bonds in order to receive interest on the bonds. The suggestions provided by the financial institution may be made by the financial institution to the user 9 through the retirement planning interface on the user device. Moreover, when presenting a suggested product to the user 9 the financial institution may also recalculate the available fund amount and/or the age parameter and display these along with the suggested products being offered.

As illustrated by block 610, after determining different optimization parameters (e.g., either requested by the user or suggested by the financial institution) the financial institution may display the suggested asset, liability, inflow and/or outflow optimization parameters, and the updated estimated optimized available fund amount and optimized age parameter to the user through the retirement planning interface 400. The optimization of the user's retirement plan is designed to increase the available fund amount and/or the age parameter for the user 9.

Block 612 of FIG. 6 illustrates that in some embodiments of the invention the user 9 may set savings and/or retirement goals, which the user 9 would like to meet. In one embodiment, the goals may include an age to which the user 9 would like his/her assets to last or an available fund amount for one or more time periods. For example, if the available fund amount and/or the age parameter, or the optimized versions of each, are not enough to meet the user's goals, than the user 9 may indicate a desired available fund amount goal and/or a desired age parameter goal. In response to the goals the financial institution may present tips or suggestions on how the user 9 may reach the desired goals. For example, the financial institution may provide the optimization information described with respect to blocks 604 through 608 described above, or other like tips or suggestions. As discussed with respect to block 610 the tips or suggestions may be presented to the user 9 in the user interface (e.g., retirement planning interface 400).

As illustrated by block 614, the financial institution may monitor the user′ transactions over time and compare the transactions (e.g., fund-inflows and fund-outflows) to the user's retirement planning (e.g., available fund amount and/or age parameter). For example, the financial institution may identify that the user's inflows are the same as previously estimated, but the user's outflows are less than what was previously estimated. However, the financial institution may also identify that the user 9 is 50% over the available fund amount calculated for the user 9 in one or more time periods (e.g., in one month, in two consecutive months, two out of three months, or the like). In some embodiments, the financial institution may provide an alert to the user, or an advisor (e.g., parent, child, guardian, financial advisor or the like) of the user, indicating that the user 9 is spending outside of the user's retirement plan related to the available fund amount. However, the alert may also include an indication that the user's inflows have remained on plan, and the user's outflows are less than what was estimated. As such, the reduction in the outflows may cover a portion of the overspending relating to the available fund amount, and this information may all be included in the alert to the user 9 and/or the user's guardian. In this way, the user 9 and/or the user's advisor may become aware of if the user is on plan, over plan, or underplan and take the necessary steps to make any reductions in costs or increases to spending or additional reinvestment. The alert may be any type of one or more alerts, such as but not limited to an e-mail, pop-up notification in the interface, message sent through the retirement planning interface or another interface, text message, phone call, mail letter, or the like. The alert may include a recalculation of the user's available fund amount and/or age parameter to illustrate how a new available fund amount that is based on the increased spending (or in other embodiments decreased spending) of the user 9 per a time period will negatively (or positively) affect the age parameter. For example, if the user has spent on average 50% more than the available fund amount for three straight months, the alert may include an estimate of the new available fund amount (e.g., increased estimate) and how the increased spending, if continued, would reduce the age parameter at which the user's funds would be depleted.

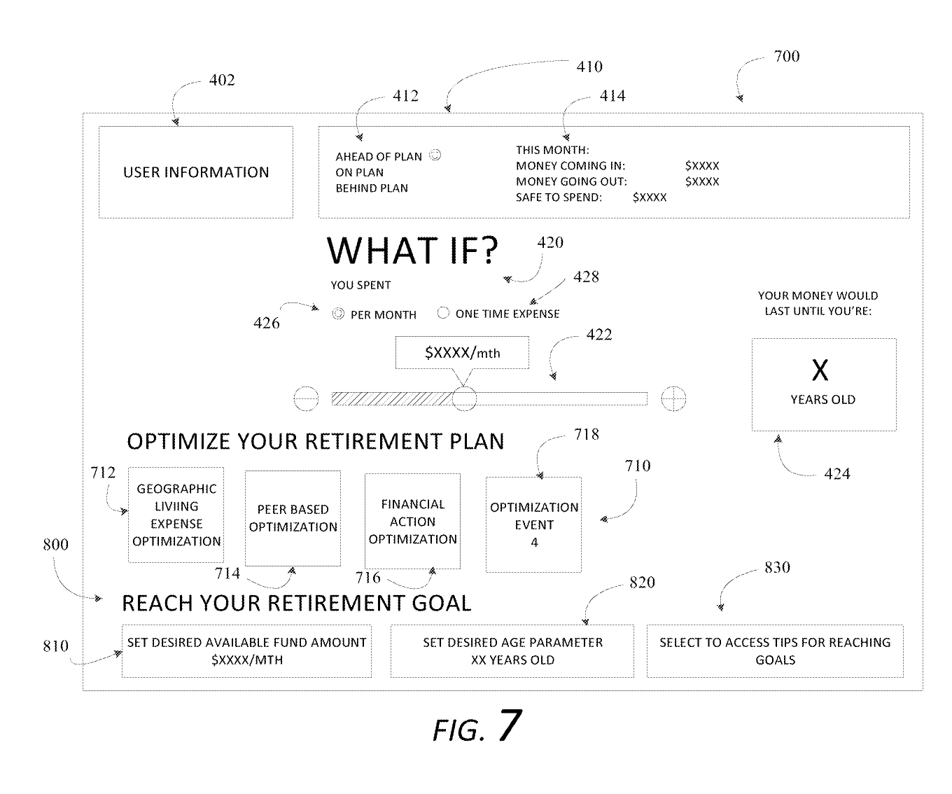

FIG. 7 illustrates an optimization interface 700, in which the retirement planning interface 400 previously described above is supplemented with additional potential selections for the user 9. For example, in one embodiment the optimization interface 700 includes an optimization section 710 and an retirement goal section 800. The optimization section 710, may include one or more optimization selections, which may or may not have been previously described herein. In one embodiment the optimization selections may include a geographic optimization section 712, a peer based optimization section 714, a financial action optimization section 716, and/or another optimization section 718. The user 9 may select any one of these optimization selections in order for the financial institution to access the information described above with respect to FIG. 6, or other information, in order to optimize the user's funds for retirement planning for increasing the user's available fund amount and/or increasing the user's age parameter. In some embodiments an optimization interface may be provided that allows the user 9 to receive additional information from the financial institution regarding optimization based on the user's selection (e.g., additional geographic information, peer information, financial action, and/or the like, as discussed above). The financial institution may present the optimized available fund amount in the optimization section and/or it may be displayed in the same sections described with respect to the retirement planning interface 400.

The optimization interface 700, or other interface described herein, in some embodiments, may also include a retirement goal section 800 (e.g., or a separate goal interface). As described above with respect to FIG. 6, the user may select and/or input a desired available fund amount goal that is a goal of the user's to reach. In other embodiments, this selection may alternatively occur in the planning estimator section 420 described with respect to the retirement planning interface 400. This may set a particular goal in which the user 9 would like to reach. Alternatively, or in addition to selecting a desired available fund amount, the user 9 may also select and/or input a set desired age parameter goal for which the user 9 is interesting in reaching with the user's funds. In response, the financial institution may provide tips or suggestions to the user 9 that may allow the user 9 to reach the user's goals. For example, the financial institution may display the tips or suggestions in the suggestions section 830 of the interface. In one embodiment, the tips or suggestions may include the amount of additional inflows that the user 9 must bring in based on a supplemental income, improved rates on the user's investments, reduced outflow amounts, reduced discretionary spending, or the like, as previously discussed.

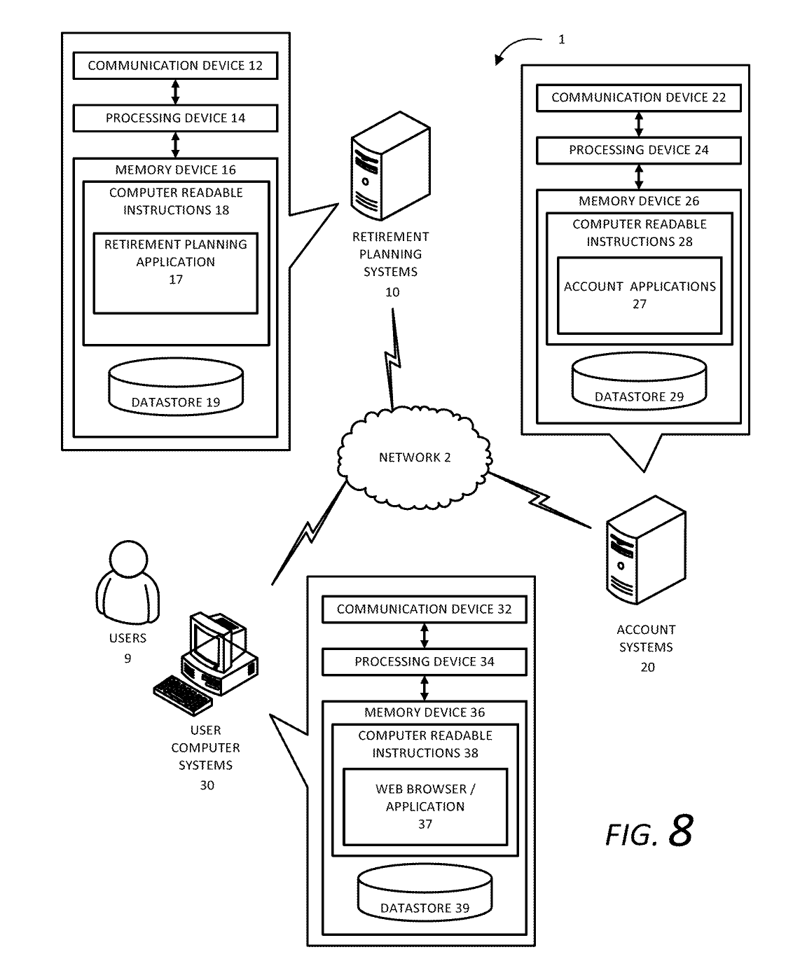

FIG. 8 illustrates a retirement planning system environment 1, in accordance with an embodiment of the present invention. As illustrated in FIG. 8, the retirement planning systems 10 are operatively coupled, via a network 2 to the asset and liability systems 20, the user computer systems 30, and other financial institution systems or third party systems (not illustrated). As discussed herein, in this way, the retirement planning systems 10 may be utilized by users 9 in order to plan for retirement using the features of the application described herein related to at least determining and recalculating an available fund amount that the user 9 has to spend over a period of time and an age parameter when the user's assets are reduced to a number that cannot cover estimated outflows, among the other features described herein. FIG. 8 illustrates only one example of embodiments of a retirement planning system environment 1, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

As illustrated in FIG. 8, the retirement planning systems 10 generally comprise a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the asset and liability systems 20, the user computer systems 30, and other financial institution systems or third-party systems. As such, the communication device 12 generally comprises a modem, server, or other device for communicating with other devices on the network 2.

As further illustrated in FIG. 8, the retirement planning systems 10 comprise computer-readable instructions 18 stored in the memory device 16, which in one embodiment includes the computer-readable instructions 18 of a retirement planning application 17. In some embodiments, the memory device 16 includes a datastore 19 for storing data related to the retirement planning systems 10, including but not limited to data created and/or used by retirement planning application 17. As discussed above the retirement planning application 17 communicates over the network 2 to send and receive information from the asset and liability applications 27, the web browser or applications 37 in the user computer systems 30, and/or other applications on other financial institution systems or third-party systems. For example, the retirement planning application accesses the values of the assets and liabilities of users 9 over the network 2 from various servers, systems, and devices that store asset and liability information of the users 9; determines estimated inflows and outflows from past inflows and outflows and any other significant future events over the network 2 from various servers, systems, and devices that store transaction information (e.g., accounts within the asset and liability applications); calculates an available fund amount that a user 9 can spend over a period of time; calculates the an age parameter indicating the age at which the user's assets will not be able to cover the user's outflows; and displays the information in an interactive interface over the network 2 that allows the user 9 to make adjustments to the available fund amount and/or the age parameter.

As further illustrated in FIG. 8, the asset and liability systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the retirement planning systems 10, user computer systems 30, and other financial institution systems or third-party systems. As such, the communication device 22 generally comprises a modem, server, or other device(s) for communicating with other devices on the network 2.

As illustrated in FIG. 8, the asset and liability systems 20 comprise computer-readable program instructions 28 stored in the memory device 26, which in one embodiment includes the computer-readable instructions 28 of an asset and liability application 27. In some embodiments, the memory device 26 includes a datastore 29 for storing data related to the asset and liability systems 20, including but not limited to data created and/or used by the asset and liability application 27. The asset and liability application 27 may be utilized by the retirement planning application 17 to access the assets and liabilities of the user 9, such as through accessing the user's financial accounts (e.g., accounts that distribute funds with restrictions and accounts that can be converted to cash quickly), ownership of property and estimates of the value of the property, applications that track the transactions of the users 9 over time, or the like. This information or other like information accessed through the asset and liability applications 27 is utilized by the retirement planning application 17 and displayed on the user computer systems 30 through a web browser/application 37.

As further illustrated in FIG. 8, the user computer systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the retirement planning systems 10, the asset and liability systems 20, and the other financial institution systems or the third-party systems. As such, the communication device 32 generally comprises a modem, server, or other devices for communicating with other devices on the network 2, and/or a display, camera, keypad, mouse, keyboard, microphone, and/or speakers for communicating with one or more users 9. Moreover, in some embodiments the user computer systems 10 may include, for example, a personal computer, a laptop, a mobile device (e.g., phone, smartphone, tablet, or personal display device (“PDA”), or the like) or other devices, or the like.

As illustrated in FIG. 8, the user computer systems 30 comprise computer-readable program instructions 38 stored in the memory device 36, which in one embodiment includes the computer-readable instructions 38 of a web browser or application 37. In some embodiments, the memory device 36 includes a datastore 39 for storing data related to the user computer systems 30, including but not limited to data created and/or used by the a web browser or application 37. The a web browser or application 37 allows the user 9, in one embodiment, to communicate with the retirement application 17 and/or asset and liability applications 27, as well as applications provided by the financial institution or other third-party, in order to access the retirement planning interface 400, send information to these applications, and receive information from these applications. In some embodiments a web browser is used to access websites, applications, or the like; however, in other embodiments a specific application (e.g., mobile application, computer application, or the like) is specifically configured to communicate with the other systems and applications within the retirement planning environment 1. In still other embodiments of the invention portions of other applications may be stored on the user computer systems 30, such as but not limited to the retirement planning application 27, the asset and liability applications 37, or other applications.

The other financial institution systems or third-party system (both not illustrated) are operatively coupled to the retirement planning systems 10, asset and liability systems 20, and user computer systems 30, through the network 2. The other financial institution systems and/or third-party systems have devices the same as or similar to the devices described for the retirement planning systems 10, asset and liability systems 20, and user computer systems 30 (e.g., communication device, processing device, memory device with computer-readable instructions, datastore, or the like). Thus, the other financial institution systems and/or third-party systems communicate with the retirement planning systems 10, asset and liability systems 20, user computer systems 30, and/or each other in the same or similar way as previously described with respect to the retirement planning systems 10, asset and liability systems 20, and/or the user computer systems 30. The other financial institution systems and/or third-party systems, in some embodiments, provide additional information about the users 9, user's assets and liabilities, or the like, which may be used by the retirement planning systems 10, or the like.

It is understood that the systems and devices described herein illustrate one embodiment of the invention. It is further understood that one or more of the systems, devices, or the like can be combined or separated in other embodiments and still function in the same or similar way as the embodiments described herein. For example, there may be multiple systems for each of the user's assets and liabilities (e.g., for each of the user's different accounts, properties owned, or the like).

The invention has been described herein as being implemented by a retirement planning application 17; however, it should be understood that in other embodiments of the invention other applications, or systems or processors running the applications may perform one or more of the steps of the present invention described above.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PEARL, SMALLTALK, C++, or any other like programming language. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks′.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. A system for accessing and analyzing assets and liabilities for retirement planning, the system comprising:
one or more memory devices; and
one or more processing devices operatively coupled to the one or more memory devices, wherein the one or more processing devices are configured to execute computer-readable program code to:
electronically continuously monitor the assets and the liabilities of a user over a network of servers from asset and liability systems of financial institutions, wherein the assets include illiquid assets and liquid assets;
determine asset values and liability values;
determine user information;
determine fund in-flows and fund out-flows for the assets and the liabilities over a past time period by analyzing transactions for the assets and the liabilities;
calculate estimated future fund in-flows and estimated future fund out-flows over a future time period from at least the fund in-flows and the fund out-flows;
determine estimated rates of return for the assets that provide returns;
calculate an available fund amount for one or more time periods and an age parameter, wherein the available fund amount indicates estimated funds the user is safe to spend above the estimated out-flows over the time period, wherein the age parameter indicates an estimated age when asset values of the liquid assets will be depleted, and wherein the available fund amount for the time period and the age parameter are based at least in part on transforming the asset values, the liability values, the estimated rates of return, the estimated future fund in-flows and the estimated future fund out-flows into the available fund amount and the age parameter;
determine the user has lifetime inflows associated with the illiquid assets;
electronically continuously calculate recommended estimated outflows for the lifetime inflows after the age parameter is met;
calculate a second available fund amount and a second age parameter, wherein the second available fund amount illustrates an amount the user may spend after the user reaches the age parameter based on the recommended estimated outflow and the lifetime inflows, and wherein the second age parameter illustrates the age at which the lifetime inflows will no longer cover the user's recommended estimated outflows; and
display the available fund amount for the time period and the age parameter, and the second available fund amount and the second age parameter on a retirement planning interface on a user device, wherein the retirement planning interface allows the user to dynamically adjust the available fund amount and/or the age parameter in real-time or near real time and recalculate a new available fund amount and a new age parameter, and a new second age parameter and a new second available fund amount for display on the retirement planning interface on the user device.

2. The system of claim 1, wherein the one or more processing devices are further configured to execute computer-readable program code to:
determine an optimization parameter that optimizes the available fund amount or the age parameters;
calculate an optimized available fund amount and an optimized age parameter; and
display the optimization parameter, the optimized available fund amount and the optimized age parameter for the time period on a retirement planning interface on a user device.

3. The system of claim 2, wherein the optimized parameter comprises an optimized location parameter; and wherein the one or more processing devices are further configured to execute computer-readable program code to:
determine current cost of living expenses of the user's current location;
determine new cost of living expenses of the new location, wherein the new cost of living expenses are less than the current cost of living expenses; and
wherein the optimized available fund amount and the optimized age parameter are based on the new cost of living expenses.

4. The system of claim 2, wherein the optimized parameter comprises a peer optimization; and wherein the one or more processing devices are further configured to execute computer-readable program code to:
determine one or more peers of the user;
determine peer decisions, wherein the peer decisions comprise at least an investment decision, inflow decision, or outflow decision of one or more peers;
determine when the peer decisions result in increases in the assets, decreases in the liabilities, increases in the fund-inflows, or decreases in the fund-outflows; and
wherein the optimized available fund amount and the optimized age parameter are based on the peer decisions.

5. The system of claim 2, wherein the optimized parameter comprises a financial product optimization; and wherein the one or more processing devices are further configured to execute computer-readable program code to:
determine financial products for the user;
determine when the financial products result in increases in the assets, decreases in the liabilities, increases in the fund-inflows, or decreases in the fund-outflows; and
wherein the optimized available fund amount and the optimized age parameter are based on the peer decisions.

6. The system of claim 1, wherein the one or more processing devices are further configured to execute computer-readable program code to:
continuously electronically monitor transactions of the user;
determine from the transactions the fund-outflows verses discretionary purchases;
determine when the discretionary purchases exceed the available fund amount for one or more time periods;
automatically update the available fund amount and the age parameter, and the second available fund amount and the second age parameter based on the discretionary purchases; and
alert the user or an advisor when the discretionary purchases exceed the available fund amount for the one or more time periods, wherein the alert includes displaying the updated available fund amount and the age parameter, and the second available fund amount and the second age parameter in the retirement planning interface on the user device.

7. The system of claim 1, wherein the one or more processing devices are further configured to execute computer-readable program code to:
display an indication of the fund in-flows used to calculate the available fund amount for the one or more time periods;
receive an indication from the user to add an unidentified fund-inflow to the fund in-flows; and
wherein calculating the available fund amount and the age parameter is further based on the unidentified fund in-flow.

8. The system of claim 1, wherein the one or more processing devices are further configured to execute computer-readable program code to:
display an indication of the fund out-flows used to calculate the available fund amount for the one or more time periods;
receive an indication from the user to add an unidentified fund out-flow to the fund out-flows; and
wherein calculating the available fund amount and the age parameter is further based on the unidentified fund out-flow.

9. The system of claim 1, wherein the one or more processing devices are further configured to execute computer-readable program code to:
receive a retirement goal related to a desired available fund amount for a time period or an age parameter;
determine one or more user actions that could achieve the desired available fund amount or the desired age parameter; and
display the one or more user actions on the retirement planning interface on the user device.

10. A computer program product for accessing and analyzing assets and liabilities for retirement planning, the computer program product comprising at least one non-transitory computer-readable medium having computer-readable program code portions embodied therein, the computer-readable program code portions comprising:
an executable portion configured to electronically continuously monitor the assets and the liabilities of a user over a network of servers from asset and liability systems of financial institutions, wherein the assets include illiquid assets and liquid assets;
an executable portion configured to determine asset values and liability values;
an executable portion configured to determine user information;
an executable portion configured to determine fund in-flows and fund out-flows for the assets and the liabilities over a past time period by analyzing transactions for the assets and the liabilities;
an executable portion configured to calculate estimated future fund in-flows and estimated future fund out-flows over a future time period from at least the fund in-flows and the fund out-flows;
an executable portion configured to determine estimated rates of return for the assets that provide returns;
an executable portion configured to calculate an available fund amount for one or more time periods and an age parameter, wherein the available fund amount indicates estimated funds the user is safe to spend above the estimated out-flows over the time period, wherein the age parameter indicates an estimated age when asset values of the liquid assets will be depleted, and wherein the available fund amount for the time period and the age parameter are based at least in part on transforming the asset values, the liability values, the estimated rates of return, the estimated future fund in-flows and the estimated future fund out-flows into the available fund amount and the age parameter;
an execuatable portion configured to determine the user has lifetime inflows associated with the illiquid assets;
an executable portion configured to calculate recommended estimated outflows for the lifetime inflows after the age parameter is met;
an executable portion configured to calculate a second available fund amount and a second age parameter, wherein the second available fund amount illustrates an amount the user may spend after the user reaches the age parameter based on the recommended estimated outflow and the lifetime inflows, and wherein the second age parameter illustrates the age at which the lifetime inflows will no longer cover the user's recommended estimated outflows; and
an executable portion configured to display the available fund amount for the time period and the age parameter, and the second available fund amount and the second age parameter on a retirement planning interface on a user device, wherein the retirement planning interface allows the user to dynamically adjust the available fund amount and/or the age parameter in real-time or near real time and recalculate a new available fund amount and a new age parameter, and a new second age parameter and a new second available fund amount for display on the retirement planning interface on the user device.

11. The computer program product of claim 10, wherein the computer-readable program code portions further comprise:
an executable portion configured to determine an optimization parameter that optimizes the available fund amount or the age parameters;
an executable portion configured to calculate an optimized available fund amount and an optimized age parameter; and
an executable portion configured to display the optimization parameter, the optimized available fund amount and the optimized age parameter for the time period on a retirement planning interface on a user device.

12. The computer program product of claim 11, wherein the computer-readable program code portions further comprise:
an executable portion configured to determine current cost of living expenses of the user's current location;
an executable portion configured to determine new cost of living expenses of the new location, wherein the new cost of living expenses are less than the current cost of living expenses; and
wherein the optimized available fund amount and the optimized age parameter are based on the new cost of living expenses.

13. The computer program product of claim 11, wherein the computer-readable program code portions further comprise:
an executable portion configured to determine one or more peers of the user;
an executable portion configured to determine peer decisions, wherein the peer decisions comprise at least an investment decision, inflow decision, or outflow decision of one or more peers;
an executable portion configured to determine when the peer decisions result in increases in the assets, decreases in the liabilities, increases in the fund-inflows, or decreases in the fund-outflows; and
wherein the optimized available fund amount and the optimized age parameter are based on the peer decisions.

14. The computer program product of claim 11, wherein the computer-readable program code portions further comprise:
an executable portion configured to determine financial products for the user;
an executable portion configured to determine when the financial products result in increases in the assets, decreases in the liabilities, increases in the fund-inflows, or decreases in the fund-outflows; and
wherein the optimized available fund amount and the optimized age parameter are based on the peer decisions.

15. The computer program product of claim 10, wherein the computer-readable program code portions further comprise:
an executable portion configured to continuously electronically monitor transactions of the user;
an executable portion configured to determine from the transactions the fund-outflows verses discretionary purchases;
an executable portion configured to determine when the discretionary purchases exceed the available fund amount for one or more time periods;
an executable portion configured to automatically update the available fund amount and the age parameter, and the second available fund amount and the second age parameter based on the discretionary purchases; and
an executable portion configured to alert the user or an advisor when the discretionary purchases exceed the available fund amount for the one or more time periods, wherein the alert includes displaying the updated available fund amount and the age parameter, and the second available fund amount and the second age parameter in the retirement planning interface on the user device.

16. The computer program product of claim 10, wherein the computer-readable program code portions further comprise:
an executable portion configured to display an indication of the fund in-flows used to calculate the available fund amount for the one or more time periods;
an executable portion configured to receive an indication from the user to add an unidentified fund-inflow to the fund in-flows; and
wherein calculating the available fund amount and the age parameter is further based on the unidentified fund in-flow.

17. The computer program product of claim 10, wherein the computer-readable program code portions further comprise:
an executable portion configured to display an indication of the fund out-flows used to calculate the available fund amount for the one or more time periods;
an executable portion configured to receive an indication from the user to add an unidentified fund out-flow to the fund out-flows; and
wherein calculating the available fund amount and the age parameter is further based on the unidentified fund out-flow.

18. The computer program product of claim 10, wherein the computer-readable program code portions further comprise:
an executable portion configured to receive a retirement goal related to a desired available fund amount for a time period or an age parameter;
an executable portion configured to determine one or more user actions that could achieve the desired available fund amount or the desired age parameter; and
display the one or more user actions on the retirement planning interface on the user device.

19. A method for accessing and analyzing assets and liabilities for retirement planning, the method comprising:
electronically continuously monitoring, by one or more processing devices, the assets and the liabilities of a user over a network of servers from asset and liability systems of financial institutions, wherein the assets include illiquid assets and liquid assets;
determining, by the one or more processing devices, asset values and liability values;
determining, by the one or more processing devices, user information;
determining, by the one or more processing devices, fund in-flows and fund out-flows for the assets and the liabilities over a past time period by analyzing transactions for the assets and the liabilities;
calculating, by a processing device, estimated future fund in-flows and estimated future fund out-flows over a future time period from at least the fund in-flows and the fund out-flows;
determining, by the one or more processing devices, estimated rates of return for the assets that provide returns;
calculating, by the one or more processing devices, an available fund amount for one or more time periods and an age parameter, wherein the available fund amount indicates estimated funds the user is safe to spend above the estimated out-flows over the time period, wherein the age parameter indicates an estimated age when asset values of the liquid assets will be depleted, and wherein the available fund amount for the time period and the age parameter are based at least in part on transforming the asset values, the liability values, the estimated rates of return, the estimated future fund in-flows and the estimated future fund out-flows into the available fund amount and the age parameter;
determining, by the one or more processing devices, the user has lifetime inflows associated with the illiquid assets;
calculating, by the one or more processing devices, recommended estimated outflows for the lifetime inflows after the age parameter is met;
calculating, by the one or more processing devices, a second available fund amount and a second age parameter, wherein the second available fund amount illustrates an amount the user may spend after the user reaches the age parameter based on the recommended estimated outflow and the lifetime inflows, and wherein the second age parameter illustrates the age at which the lifetime inflows will no longer cover the user's recommended estimated outflows; and
displaying, by the one or more processing devices, the available fund amount for the time period and the age parameter, and the second available fund amount and the second age parameter on a retirement planning interface on a user device, wherein the retirement planning interface allows the user to dynamically adjust the available fund amount and/or the age parameter in real-time or near real time and recalculate a new available fund amount and a new age parameter, and a new second age parameter and a new second available fund amount for display on the retirement planning interface on the user device.

20. The method of claim 20, further comprising:
determining, by a processing device, an optimization parameter that optimizes the available fund amount or the age parameters;
calculating, by a processing device, an optimized available fund amount and an optimized age parameter; and
displaying, by a processing device, the optimization parameter, the optimized available fund amount and the optimized age parameter for the time period on a retirement planning interface on a user device.
